(19) United States
(12) Patent Application Publication
(10) Pub. No.: US 2002/0155752 A1
(43) Pub. Date: Oct. 24, 2002

(54) Battery jumper cable connection apparatus and methods

(76) Inventors: Stuart Trevor Winkle, Auckland (NZ); Jeffrey David Cowl, Auckland (NZ)

Correspondence Address: YOUNG & THOMPSON, 745 SOUTH 23RD STREET 2ND FLOOR, ARLINGTON, VA, 22202

(21) Appl. No.: 10/116,045

(22) Filed: Apr. 5, 2002

(30) Foreign Application Priority Data
Apr. 5, 2001 (NZ) 510958

(51) Int. Cl. H01R 11/00

(52) U.S. Cl. 439/504

(57) ABSTRACT

Polarity independent jumper cables are provided for connecting vehicle batteries in parallel, for example when trying to start a vehicle that has a flat battery. The apparatus disclosed has terminal connectors to connect to the terminal posts of each battery. The terminal connectors lead to a switching and control circuit that automatically determines the batteries polarities and makes connections to connect the batteries in parallel, so that users do not need to have any knowledge of the battery polarities. In particular, an indication of the relative state of charge of the batteries is provided prior to the circuit establishing the connections so that when the connection is made, it is made for a predetermined period of time in order to control the current flow through the apparatus. Furthermore, the connection between the batteries is made only when the change in load is sensed on one of the batteries, for example when a vehicle starter motor is connected to one of the batteries.

### FIELD OF THE INVENTION

This invention relates to polarity independent jumper cable apparatus for connecting batteries in parallel. The invention also relates to methods of operation of such apparatus.

### BACKGROUND OF THE INVENTION

It has long been recognised that battery cables which are used to connect vehicle batteries in parallel are easily misconnected by those who have little knowledge of automotive electrics. Misconnection of cables between vehicle batteries can cause very significant problems. At the lower end of the scale, misconnection can simply mean some sparks and noise which can give the user a fright. At the other end of the scale, misconnection can result in a battery literally exploding and can cause significant damage to other vehicle electrics such as vehicle computers, electronic management systems and the like. There is also a risk of personal injury to the user.

Some proposals have been made to provide a polarity independent set of jumper cables. By “polarity independent” is meant a cable set which has an associated electrical or electronic device that enables the cables to always provide a correct and desired set of electrical connections between two batteries independently of the manner in which the cables are actually arranged in use.

One proposal has been set forth in U.S. Pat. No. 4,871,957 to Taranto. Another has been proposed in U.S. Pat. No. 5,795,182 to Jacob. Both of these proposed systems include some form of polarity detector to achieve the overall object of ensuring that the negative terminals and positive terminals of the batteries are directly connected to each other to form the desired parallel connection arrangement. However, both devices suffer disadvantages. In particular, Taranto has no means for determining when the terminals have been disconnected from the battery. Therefore, it is quite feasible for the jumper cables to be connected to thereby activate the device by having the desired connections made, and the user then disconnecting or inadvertently allowing one of the jumper cable leads to become disconnected and short against the body of the vehicle thereby causing the disadvantages of incorrect connection. Jacob has a delay circuit for returning the device to its unconnected state after disconnection from one of the batteries, but it is still possible for a user to encounter the same problem as discussed above. Jacob also provides an undercurrent protector. The disadvantage with current detection is that it can be difficult and expensive to implement, so it would be highly desirable to have a device which obtained information from the battery terminal voltage and use this to derive information regarding state of charge of the batteries relative to each other so that appropriate connection or disconnection could be made. In this way connection would only be made for a time period sufficient to start the disabled vehicle.

### OBJECT OF THE INVENTION

It is an object of the present invention to provide apparatus or a method for operating polarity independent battery jumper cable apparatus which will at least go some way toward overcoming disadvantages associated with the prior art, or which will at least provide the public with a useful choice.

### SUMMARY OF THE INVENTION

Accordingly in one aspect the invention consists in polarity independent battery jumper apparatus for operative connection to a first battery and a second battery, each battery having a positive and a negative terminal. The apparatus includes a first terminal pair for connecting to the first battery and a second terminal pair for connecting to the second battery. Polarity sensing means are provided for sensing the polarities of the battery terminals and providing a signal which is representative of the battery polarities. There are also load sensing means that provide a signal that indicates the likely load on the apparatus in response to operative connection between the batteries. Switching means that are responsive to the signal from the polarity sensing means make the operative electrical connections between battery terminals of like polarity for a time period which is dependent on the signal from the load sensing means.

Therefore, if there is likely to be a high current when the operative connection is made, the time for which the switching means remain connected is predetermined so as to prevent possible damaging surges of current.

The load sensing means indicates a likely load by sensing the state of charge of the batteries relative to each other. In the preferred embodiment, an indication of the state of charge is provided by sensing the voltage between the terminals of each of the batteries.

The predetermined time period for which the switching means is closed dependent upon the likely load can be determined in a number of ways. In the preferred embodiment, the relative voltages between the batteries are determined, and the difference between the voltages i.e. their relative magnitude is used to determine a predetermined period of time. As the difference in magnitude between the battery voltages increases, the predetermined time period increases. Discreet predetermined periods may be chosen dependent upon the magnitude of the relative voltages. Therefore, for a first range of relative voltages, a first time period may be selected, and for a second range of relative voltages, a second predetermined time period may be selected. If the first range is greater than the second range, then the first predetermined time period will be less than the second predetermined time period. Therefore, a small difference in battery voltages is likely to mean a low current surge i.e. a low load on the apparatus, so the batteries may be safely connected together for a longer period of time, for example, two seconds. On the other hand, a large difference in relative battery voltages indicates that a high surge of current is likely to occur upon connection, so the connection time is made shorter, for example half a second.

The load sensing means can also sense a significant change in load. For example, this may comprise a vehicle starter motor being connected across the battery. In the preferred embodiment, the switching means do not make the operative connection between battery terminals until a significant change in load, such as connection of a starter motor, has been sensed.

The significant change in load is sensed, in the preferred embodiment, by the load sensing means sensing a significant drop in voltage of the battery across which the load is connected.

Once the switching means has connected battery terminals for a predetermined period of time that is dependent on the signal from the load sensing means, the load sensing means again sense the load and provide a further signal. This further signal is used by the sensing means to connect the terminals for another period of time which is dependent upon that further signal. In this way, the batteries may be successfully operatively connected together in such a way that damaging current flows are avoided.

The polarity sensing means also include means to detect a change in polarity and provide a signal relating to this to the switching means. The switching means is then responsive to this signal of polarity change to disconnect the connections that may have been made between the terminals. The polarity change signal is also provided should the apparatus be disconnected from one or more of the battery terminals. In this way, if a connector of the apparatus to one of the batteries falls off, or is mistakenly connected to another piece of conductive material for example, then an electrical circuit cannot be completed and this avoids any potential damage.

In a further aspect the invention provides polarity independent jumper apparatus for operative connection to a first battery and a second battery which each have a positive and a negative terminal. The apparatus includes a first terminal pair for connecting to the first battery, and a second terminal pair for connecting to the second battery. Polarity sensing means for sensing the polarities of the battery terminals and providing a signal representative of the battery polarities are provided together with a load sensing means to sense a change in the load in one of the batteries and to provide a signal representative of the change in load. Switching means which are responsive to the signals from the polarity sensing means and the load sensing means are provided to make electrical connections between battery terminals of like polarity when a change in load is sensed.

In the preferred embodiment the load sensing means monitor the battery terminal voltages and a significant change in the voltage of the terminals of one of the batteries is detected. A change in load that is sufficiently significant to be detected by the apparatus is a load such as a vehicle starting motor being connected across one of the batteries.

In another aspect the invention provides the method of connecting a first battery to a second battery independent of the polarity of the batteries, each battery having a positive and negative terminal. The method includes the steps of sensing the polarity of the battery terminals, sensing the likely load of the apparatus in response to operative connection of the batteries, and making operative electrical connections between battery terminals of like polarity for a time period dependent on the likely load.

In yet another aspect, the invention provides a method of connecting a first battery to a second battery independently of the polarity of the batteries, each battery having a positive and a negative terminal. The method includes the steps of sensing the polarities of the batteries, sensing a change in load of one of the batteries, and operatively interconnecting the batteries by making electrical connections between battery terminals of like polarity when the change in load is sensed.

To those skilled in the art to which the invention relates, many changes in constructions and widely different embodiments and applications of the invention will suggest themselves without departing from the scope of the invention as defined in the appended claims. The disclosure and descriptions herein are purely illustrative and are not intended to be in any sense limiting.

### DRAWING DESCRIPTION

A preferred embodiment provided as one example of the invention will now be described below with reference to the drawings in which:

FIG. 1 is a sketch of battery jumper cable apparatus according to the invention; and

FIG. 2 is a circuit diagram of a circuit which enables operation of the apparatus of FIG. 1.

### DESCRIPTION OF PREFERRED EMBODIMENT

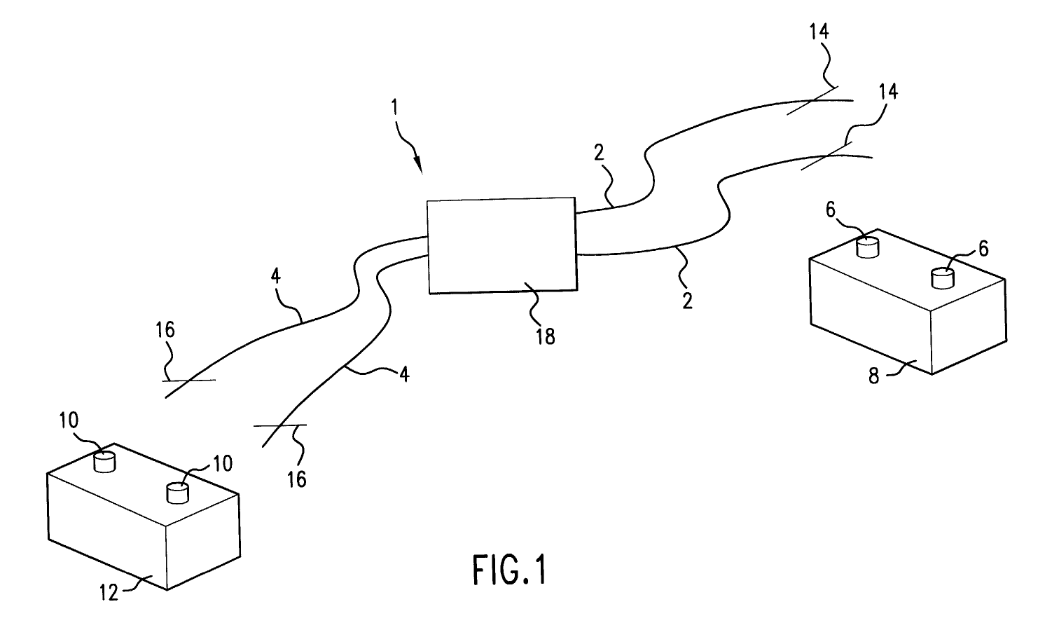

Referring to FIG. 1, apparatus according to the present invention is shown generally referenced 1. The apparatus includes jumper cables comprising a first set of cables 2 and a second set of cables 4. Cable set 2 is generally intended to be connected to the terminals 6 of a first battery 8, and cable set 4 is intended to be connected to the terminals 10 of a second battery 12. Each cable set 2 and 4 has terminal connectors, such as jaws 14 and 16 respectively, connected at the ends thereof. In use the jaws 14 and 16 are spring loaded, for example, and have appropriate handles for users to grasp the jaws, open them and allow the jaws to return under the force of a spring or other appropriate biasing mechanism so that the jaws make a good electrical connection to the terminal posts 6 and 10 of the batteries.

The cable sets 2 and 4 have the other ends of their cables provided into a central housing 18. This housing does not need to be provided centrally between the cables, but in most instances it will be practical and therefore desirable to do so. The housing 18 contains in use appropriate electronic and electrical apparatus to determine the polarities of the battery terminals by looking at the polarities of the cables 2 and 4 as they are provided to the housing and then makes appropriate connections between the cables to ensure that terminals of like polarity between the batteries are connected to each other. In this way, the batteries are connected to each other in parallel in use and are therefore able to source more current to a vehicle starter motor for example that may be connected across one of the batteries.

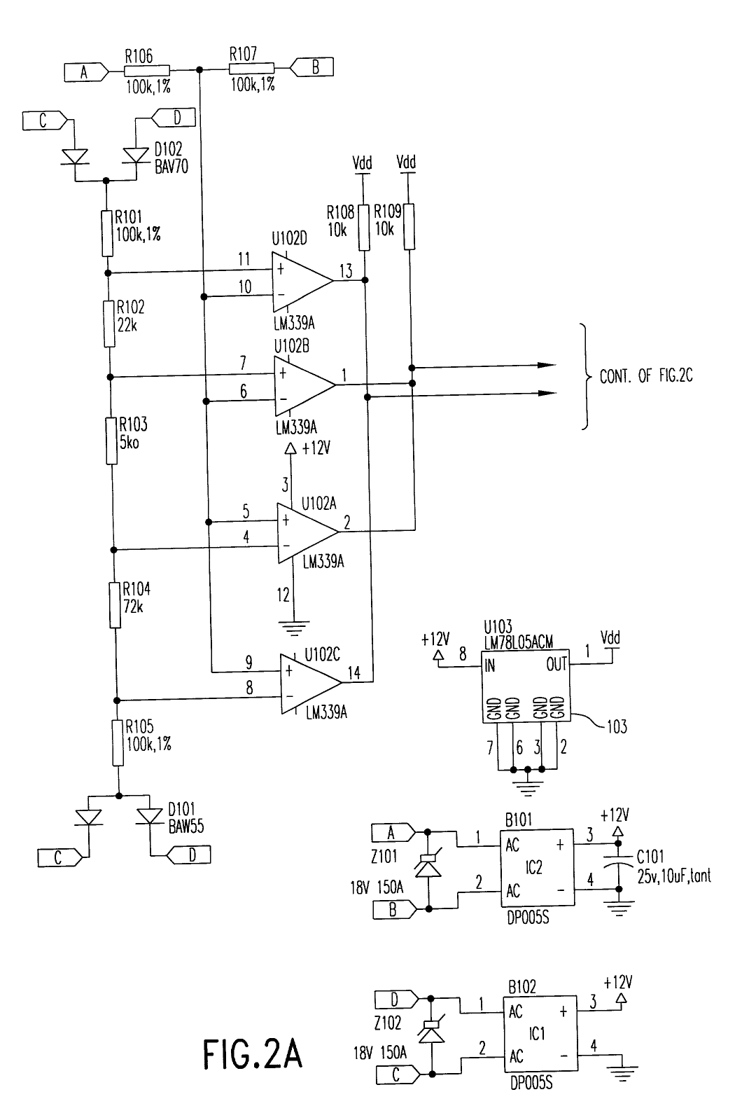

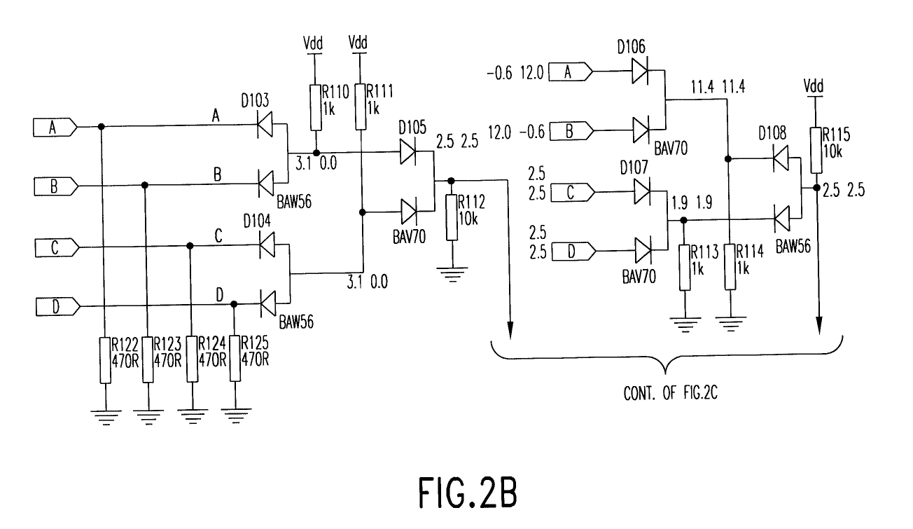

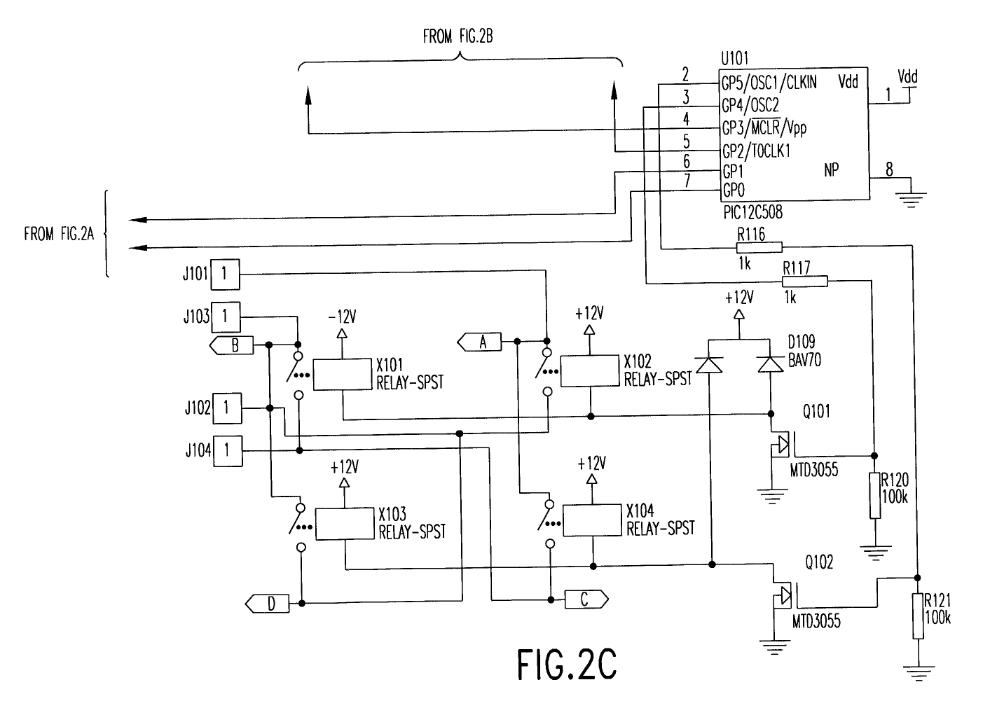

Turning now to FIG. 2, a circuit diagram of a circuit which is in use provided within housing 18 of FIG. 1 is shown. In FIG. 2, the terminal connections a, b, c and d represent the four terminals of the two batteries 8 and 12 of FIG. 1. Terminals a and b are connected to one set of the jumper cables 2 or 4 and terminals c and d are connected to other set of the jumper cables 2 or 4.

Firstly, a power supply is derived using integrated circuits IC1 and IC2, the inputs to these circuits being terminals a and b, and c and d respectively. The arrangement is such that if either of terminals a and b or c and d are connected to battery terminals, in whichever polarity, a 12 volt (or other voltage dependent on the battery system used in the vehicle, for example 24 volt) output will be obtained. For the purposes of this example, the vehicle voltage will be assumed to be 12 volts. This 12 volt output (referenced +12 v) in FIG. 2 is then supplied to an input of a voltage regulator reference IC3. This regulator then provides an appropriate high voltage output (referenced VDD) which is used to supply the logic circuitry and the microprocessor which is referred to later. VDD is preferably approximately 5 volts DC. The system is largely independent of the vehicle battery voltage.

The terminals c and d are provided via diodes D101 and D102 to a resistor chain R101-R105. As can be seen, the resistor chain provides a voltage divider which provides a number of reference voltages to operational amplifiers 102A-102D. The other inputs to the operational amplifiers are supplied by the mid point of the voltage between terminals a and b. The mid point voltage is obtained by voltage dividers provided by resistors R106 and R107. The output of the op amps U102A-103D are grouped such that U102C and D are linked together, the output usually being high and the output of U102A and B are linked together, again the output usually being high. As will be seen, if the output of U102C and D goes low, then there will be a large discrepancy between the voltages of the two batteries. If the output of U102A and B goes low, then there will be a smaller discrepancy in battery voltages. If there is no change i.e. the outputs all remain high, then the battery voltages will be almost the same.

The outputs in the op amps are provided to pins 6 and 7 of the microprocessor referenced UP in the drawings. The microprocessor uses logic signals provided from the relative battery voltage data to time the period of electrical connection between batteries. It is well known that battery terminal voltage provides at least an indication of state of charge of a battery. More importantly, in the present instance, the relative overall terminal voltages of the batteries will determine the extent or the amount of required energy to supply from one battery to the other once an electrical interconnection is made. Therefore, if there is a large discrepancy between the voltages between battery terminals, the microprocessor will make the connection between batteries for a short period of time, for example half a second. If the voltages are very similar, then the microprocessor will make the connections between dead batteries for a relatively long period of time, for example one or two seconds. At the end of that time period, the microprocessor will again sample the terminal voltages and make a further assessment of the relative state of charge. If the reassessment indicates that the battery voltages are more similar in magnitude, then the connection will be made for a shorter period of time. It will be appreciated that the assessment performed by the microprocessor will be performed very quickly, therefore a nearly smooth transition or control of currents flowing in the circuit is effected. Accordingly, the circuit provides a simple way of predicting likely current flow, and times the connection accordingly to avoid excessive currents.

Also, this part of the circuit enables the microprocessor to detect a large change in voltage of one of the batteries. Such a change will occur when a heavy electrical load, such as the vehicle starter motor, is electrically connected to the relevant battery. In the preferred embodiment, this information is used by the microprocessor to determine when the connections between batteries are actually required to be made. Therefore, when the cables are connected to the battery, the device does not immediately electrically connect the batteries together. When the ignition key is turned to connect the starter motor the device detects this and makes the appropriate connections for the required time period. The circuitry used to determine the polarity information required to make the appropriate connections is described below.

The terminals a-d are also connected to diode pairs D103, D104 and D105. As can be seen, the diode pair D105 will be normally high, thus applying a high signal to pin 4 of the UP. However, if either terminals a or c, or b or d comprise a negative terminal, then the input to pin 5 of the UP will go low.

Similarly, diode pairs D106, D107 and D108 are also arranged but this time to test whether terminal a or b is high or one of terminals c or d is high. If either of these situation occurs, then the input to pin 5 of the UP will go high.

From the signals on pin 4 and 5, the UP can make a comparison and by a process of logic know terminals a and b is the high and low terminals and which of terminal c and d is the high or low terminal. Therefore, the polarity of the battery terminals may be determined.

Once the polarities are known in this fashion, the UP can control the output of pins 2 and 3 to provide an appropriate signal to drive FETS Q101 and Q102 which in turn drive relays X101 -X104. If FET Q101 is turned on, then relays X101 and X102 are activated to thereby interconnect terminals b and c and terminals a and d. On the other hand, if Q102 is activated, then relays X103 and X104 are activated to interconnect terminals a and c and b and d. As mentioned above, the time for which the relays are turned on is determined by the microprocessor in response to predicted current flow. An appropriate look-up table can be provided in the memory of the up for connection time based on sampled terminal voltages. Accordingly, the circuit does not need to go to any expensive or difficult length to measure or determine actual current flow. Instead, a very simple and effective method is used to predict current flow from the battery terminal voltages.

The invention provides the following important advantages: The cables allow a vehicle with a flat battery to be jump started in fully user safe manner. The circuit will only be active once all leads are connected, and the battery voltages are not substantially the same.

The circuit can derive power for control from a connected battery or batteries. i.e. only one battery needs to be connected to the terminals and the power for the control circuitry is derived and provided regardless of the polarity of the connection.

The logic circuitry asserts a “true” signal when both the source and destination batteries are connected and it asserts “false” signal when only when one battery is connected. Therefore, the circuit will not be operative when only one battery is connected and therefore avoid the possibility of the unconnected cables being connected to each or to something else to provide an electrical hazard.

The circuit componentry is chosen such that if a difference in voltage between the source and destination battery is greater 0.5 volts, then a signal is provided to the microprocessor. If the difference in voltage is greater than 2 volts, then a further signal is provided to the logic circuitry. In this way, a measure of control can be provided over the likely current flow between batteries.

A high current relay circuit consisting of four relays is provided, each relay being connected to one high current jumper lead.

The circuit provides a micro controller that uses logic signals to determine that it is safe to connect four terminals of the two batteries, or which way to connect them using the four relays, and how long before automatic disconnection occurs.

The invention also includes a surge suppression circuit to protect electronic devices that may be present in either or both vehicles.

It will be seen that any improper use will result in non-operation of the circuit, including connection of terminals a and c to one battery and terminals b and d to another.

The micro controller preferably includes fuzzy logic software. This provides immediate advantages particularly when it comes to current control between batteries. The invention also uses generic, off the shelf components. This results in cost savings and more efficient assembly. The jumper cables inherently return to the disconnected state when they are no longer required i.e. the vehicle starter motor has been de-energised. Finally, the cables have no external controls or indicators which are likely to confuse users. Therefore, no training or knowledge of the equipment is required for the effective use of the equipment.

1. Polarity independent battery jumper apparatus for operative connection to a first battery and a second battery, each battery having a positive and a negative terminal, the apparatus including
a first terminal pair for connecting to the first battery,
a second terminal pair for connecting to the second batter,
polarity sensing means for sensing the polarities of the battery terminals and providing a signal representative of the battery polarities,
a load sensing means to provide a signal indicative the likely load on the apparatus in response to operative connection between the batteries, and
a switching means responsive to the signal from the polarity sensing means to make operative electrical connections between battery terminals of like polarity for a time period dependent on the signal from the load sensing means.

2. Apparatus as claimed in claim 1 wherein the load sensing means provides an indication of a relative state of charge of the batteries.

3. Apparatus as claimed in claim 2 wherein the state of charge is sensed by sensing the voltage between the terminals of each of the batteries.

4. Apparatus as claimed in claim 3 wherein the switching means is activated for a first predetermined period of time if the battery voltages are within a first relative range, and the switching means is activated for a second predetermined period of time if the battery voltages are within a second relative range.

5. Apparatus as claimed in claim 4 wherein if the magnitude of the first relative range is less than the magnitude of the second relative range, then the first predetermined time period is longer than the second predetermined period.

6. Apparatus as claimed in claim 1 wherein the load sensing means includes means to sense a significant change in load.

7. Apparatus as claimed in claim 6 wherein the switching means make the connection between terminals once a significant change in load has been sensed.

8. Apparatus as claimed in claim 6 wherein the significant change in load is sensed by the load sensing means as a drop in battery voltage.

9. Apparatus as claimed in claim 8 wherein the dropping battery voltage results from the relevant battery being connected to a heavy electrical load.

10. Apparatus as claimed in claim 1 wherein once the switching means have connected the battery terminals for the predetermined period of time dependent on the signal from the load sensing means, the load sensing means sense the load again and provide a further signal, which further signal used by the sensing means to connect the terminals for another period of time dependent upon the further signal.

11. Apparatus as claimed in claim 1 wherein the polarity sensing means include means to detect a change in polarity and provide a polarity change signal to the switching means, and the switching means is responsive to the polarity change signal to disconnect the connections between the terminals.

12. Apparatus as claimed in claim 11 wherein the change in polarity includes disconnection of the apparatus from one or more of the terminals.

13. Polarity independent battery jumper apparatus for operative connection to a first battery and a second battery, each battery having a positive and a negative terminal, the apparatus including
a first terminal pair for connecting to the first battery,
a second terminal pair for connecting to the second battery,
polarity sensing means for sensing the polarities of the battery terminals and providing a signal representative of the battery polarities,
a load sensing means to sense a change in load on one of the batteries and to provide a signal indicative of the change in load, and
a switching means responsive to the signals from the polarity sensing means and the load sensing means to make electrical connections between battery terminals of like polarity when the change in load is sensed.

14. Apparatus as claimed in claim 13 wherein the load sensing means monitor the battery terminal voltages, and a significant change in voltage of the terminals of one of the batteries is detected.

15. Apparatus as claimed in claim 14 wherein the significant change in voltage is caused by a significant electrical load on one of the batteries, such as connection of the relevant battery to a vehicle starter motor.
